(19) United States
(12) Patent Application Publication
(10) Pub. No.: US 2011/0048553 A1
(43) Pub. Date: Mar. 3, 2011

(54) PRESSURE REGULATOR

(75) Inventors: Yasuaki Nakamura, Shizuoka (JP); Hideto Usui, Shizuoka (JP); Satoshi Kamiyama, Shizuoka (JP); Mitsuo Hirotomi, Shizuoka (JP)

(73) Assignee: TOKAI CORPORATION, Tokyo (JP)

(21) Appl. No.: 11/996,955

(22) PCT Filed: Jul. 25, 2006
(86) PCT No.: PCT/JP2006/314698

§ 371 Date: Mar. 29, 2010

(30) Foreign Application Priority Data
Jul. 25, 2005 (JP) 2005-213653

(51) Int. Cl. F16K 7/00

(52) U.S. Cl. 137/528

(57) ABSTRACT

A pressure regulator includes a housing having an inlet port through which pressurized fluid at a primary pressure is supplied, and a discharge port through which pressurized fluid at a secondary pressure lower than the primary pressure is discharged, and at the same time having a flow passage formed therein to extend from the inlet port to the discharge port, and a pressure control mechanism which is disposed on the flow passage to reduce the primary pressure to the secondary pressure. The pressure control mechanism includes a movable body including a diaphragm which is displaced in response to change in the pressure of the fluid and the movable body is provided with an abutment portion which is brought into abutment against a part of the housing to prevent the movable body from being excessively displaced when the primary pressure becomes excessively high.

### BACKGROUND OF THE INVENTION

1. Field of the Invention

This invention relates to a pressure regulator where the pressure of pressurized fluid such as gas or liquid is reduced to a predetermined secondary pressure from a primary pressure by way of a pressure control mechanism, and particularly to such a pressure regulator in which the pressure control mechanism includes a diaphragm.

2. Description of the Related Art

As disclosed in FIG. 1 of Japanese Unexamined Patent Publication No. 2004-318683, there has been a pressure regulator provided with a diaphragm and a governor mechanism (pressure control mechanism) having a pressure control valve interlocked therewith. The governor mechanism of the pressure regulator has a supporter formed with a flange mounted on the diaphragm. The supporter is urged with a predetermined force by a pressure control spring to control the pressure control valve interlocked with the diaphragm at a predetermined pressure. The pressure control valve is positioned in the passage of the pressurized fluid and the pressure of the fluid downstream of the pressure control valve, that is, the secondary pressure, is controlled to be lower than the pressure of the fluid supplied from upstream of the pressure control valve, that is, the primary pressure.

As a technique of the prior art, there has been known, as disclosed in FIG. 1 of Japanese Unexamined Patent Publication No. 8 (1996)-303773, a governor mechanism employed in a cassette-type gas cylinder used in a gas appliance. This governor mechanism is for leading the gas in a gas cylinder to a burner under a controlled pressure and provided with a regulation chamber parted with a diaphragm in the casing of the governor mechanism and a valve (a pressure control valve) open/close lever interlocked with the diaphragm in the regulation chamber. A mechanism for protecting the pressure regulator and for preventing the gas cylinder from exploding when the pressure in the gas cylinder is excessively high due to heat applied to the gas cylinder is provided in the governor mechanism and the gas cylinder. When the pressure in the gas cylinder is increased to an excessively high pressure, the mechanism causes the pressure in the gas cylinder to act on a safety valve in the governor mechanism to urge the safety valve to the retracted position. In response to refraction of the safety valve, a stem of the gas cylinder which has been abutted against the safety valve stretches to close an off valve interlocked with the stem to cut the gas supply to the governor mechanism from the gas cylinder.

In the pressure regulator disclosed in FIG. 1 of Japanese Unexamined Patent Publication No. 2004-318683, the pressurized fluid supplied from the pressurized fluid supplying system, the flow rate of the pressurized fluid passing through the pressure control valve is controlled to control the pressure of the fluid by displacing the pressure control valve between the high pressure and the low pressure. However, the fluid pressure on the high pressure side of the pressure control valve is sometimes excessively raised from a predetermined temperature for some reasons including an increase in the environmental temperature or collapse of the container accommodating the pressurized fluid. When the pressure regulator is operated in this state, there is a fear that the pressure control valve which controls the amount of the pressurized fluid flowing into the low pressure side from the high pressure side and the diaphragm interlocked with the pressure control valve are excessively displaced to deform the pressure control valve to be unrestorable. In this case, the pressure control valve comes not to adequately function.

Further, in the pressure regulator disclosed in FIG. 1 of Japanese Unexamined Patent Publication No. 8 (1996)-303773, a complicated mechanism is required for protecting the gas appliance against an excessively high gas pressure to be supplied, and an excessively high gas pressure cannot be dealt with unless association with the gas cylinder, not only the gas appliance.

### SUMMARY OF THE INVENTION

In view of the foregoing observations and description, the primary object of the present invention is to provide a pressure regulator which is relatively simple in structure and high in reliability where the pressure control mechanism cannot be damaged even by an excessively high primary fluid pressure.

Another object of the present invention is to provide a pressure regulator which can protect the pressure control mechanism by a single pressure regulator.

In accordance with the present invention, there is provided a pressure regulator comprising

a housing having an inlet port through which pressurized fluid at a primary pressure is supplied, and a discharge port through which pressurized fluid at a secondary pressure lower than the primary pressure is discharged, and at the same time having a flow passage formed therein to extend from the inlet port to the discharge port, and

a pressure control mechanism which is disposed on the flow passage to reduce the primary pressure to the secondary pressure, where the improvement comprises that

the pressure control mechanism comprises a movable body including a diaphragm which is displaced in response to change in the pressure of the fluid and

the movable body is provided with an abutment portion which is brought into abutment against a part of the housing to prevent the movable body from being excessively displaced when the primary pressure becomes excessively high.

The movable body may be provided with a pair of members which are associated with each other from a first surface facing the flow passage of the diaphragm and from a second surface opposite to the first surface to support therebetween the diaphragm and the abutment portion may be formed in the portion projecting toward the second surface of the movable body.

The housing may be formed with a stopper portion comprising a projection opposed to the abutment portion.

The abutment portion may be a projection opposite to the inner surface of the housing.

According to the pressure regulator of the present invention, the pressure control mechanism which reduces the primary pressure to the secondary pressure has a movable body including a diaphragm which is displaced in response to change in the pressure of the fluid and the movable body is provided with an abutment portion which is brought into abutment against a part of the housing to prevent the movable body from being excessively displaced when the primary pressure becomes excessively high. Accordingly, the pressure regulator of the present invention exhibits the following result. When the movable body of the pressure control mechanism tends to be excessively displaced by an excessively high primary pressure, the movable body abuts against a part of the housing and an excessive displacement of the movable body is prevented, whereby the pressure control mechanism is prevented from being deformed to be unrestorable and/or being damaged and a pressure regulator which is simple in structure and high in reliability can be obtained. Further, a function of protecting a pressure regulator against an excessively high pressure can be realized by a pressure regulator by itself.

When the movable body is provided with a pair of members which are associated with each other from a first surface facing the flow passage of the diaphragm and from a second surface opposite to the first surface to support therebetween the diaphragm and the abutment portion is formed in the portion projecting toward the second surface of the movable body, the abutment portion can be formed on the movable body with simple structure.

Further, when the housing is formed with a stopper portion comprising a projection opposed to the abutment portion, the stopper portion can be formed with simple structure, and at the same time, since formation of the projection contributes to increase in the rigidity of the housing, a pressure regulator which is high in reliability can be obtained.

When the abutment portion is in the form of a projection opposite to the inner surface of the housing, the abutment portion can be formed with simple structure, and at the same time, since, a rigidity is given to the abutment portion, the movable body is less apt to be broken and a pressure regulator which is high in reliability can be obtained.

### BRIEF DESCRIPTION OF THE DRAWINGS

FIG. 1 is an exploded perspective view showing a pressure regulator in accordance with a first embodiment of the present invention cut along a circumference around a shaft passing through the center thereof by a range of about 90 degrees,

FIG. 2 is a fragmentary enlarged view of FIG. 1,

FIG. 3 is a fragmentary enlarged view showing a lower part of the pressure regulator of FIG. 1 cut along a circumference around a shaft passing through the center thereof by a range of about 90 Åã,

FIG. 4A is a cross-sectional view showing the normal state of the pressure regulator of FIG. 1 connected thereto a pressure vessel,

FIG. 4B is a view similar to FIG. 4A showing a state of the pressure regulator where the pressure therein is increased excessively high,

FIG. 5 is an enlarged view of a part V surrounded by a chained line in FIG. 4B showing the diaphragm supplied thereto fluid of an excessively high pressure,

FIG. 6A is a cross-sectional view showing the normal state of the pressure regulator in accordance with a second embodiment of the present invention,

FIG. 6B is a view similar to FIG. 6A showing a state of the pressure regulator where the supply pressure is increased excessively high,

FIG. 7A is a cross-sectional view showing the normal state of the pressure regulator in accordance with a third embodiment of the present invention,

FIG. 7B is a view similar to FIG. 7A showing a state of the pressure regulator where the supply pressure is increased excessively high,

FIG. 8 is a fragmentary enlarged cross-sectional view showing a first modification of the projection of the supporter and the projection of the cover casing in the first embodiment,

FIG. 9 is a fragmentary enlarged cross-sectional view showing a second modification of the projection of the supporter and the projection of the cover casing in the first embodiment, and

FIG. 10 is a fragmentary enlarged view showing a modification of the supporter in the third embodiment.

### DETAILED DESCRIPTION OF THE INVENTION

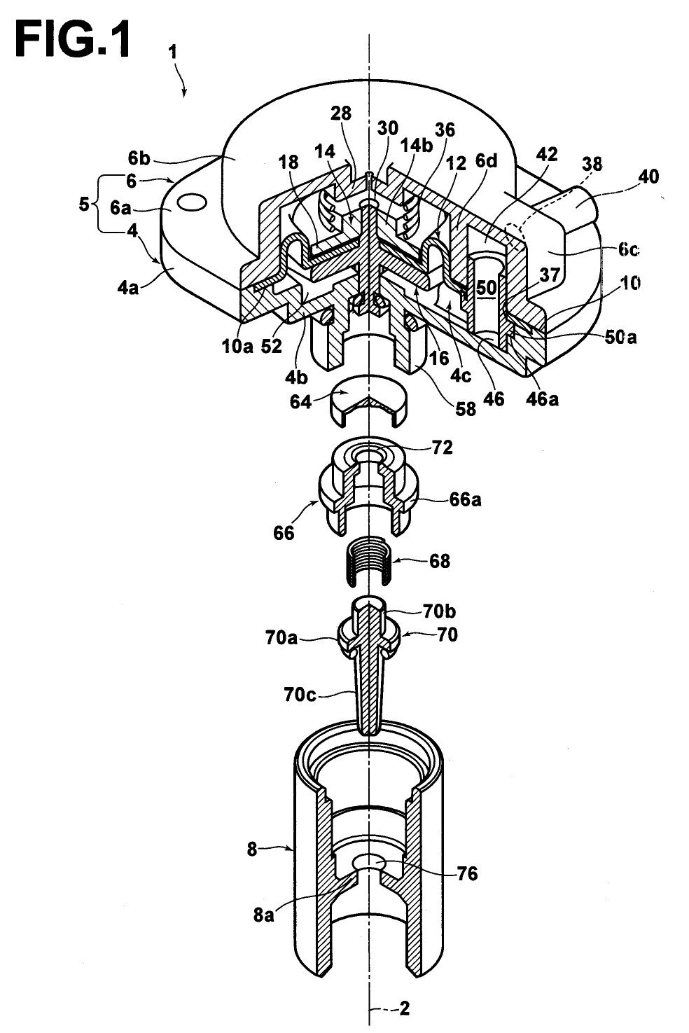

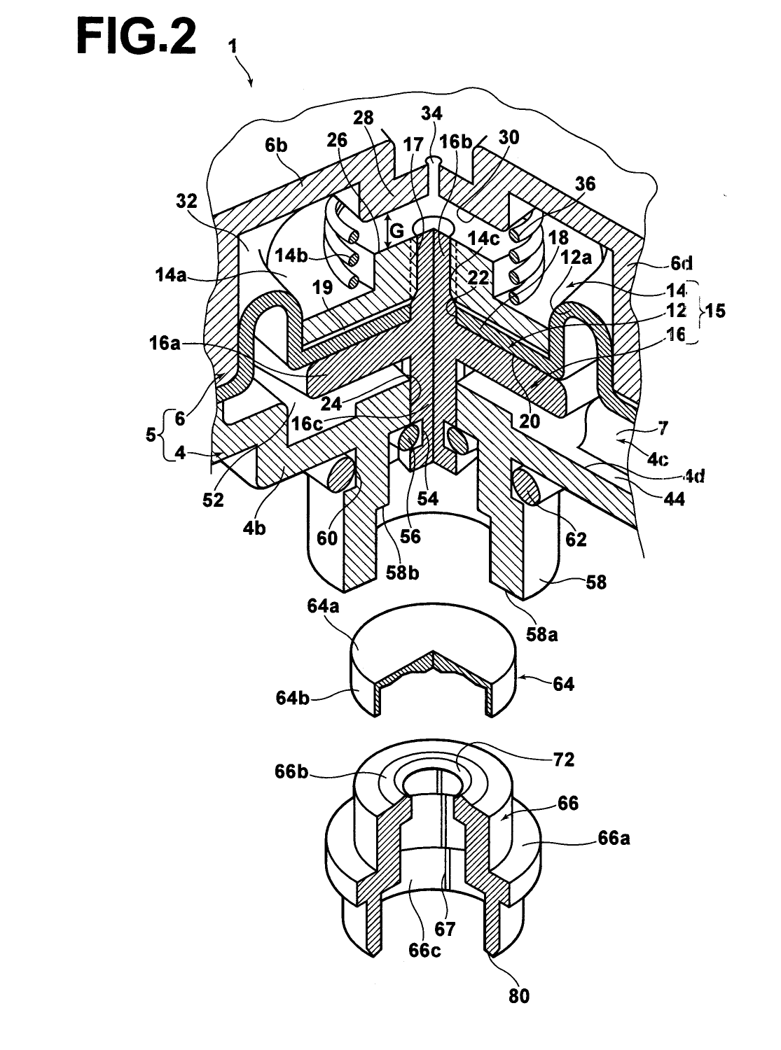

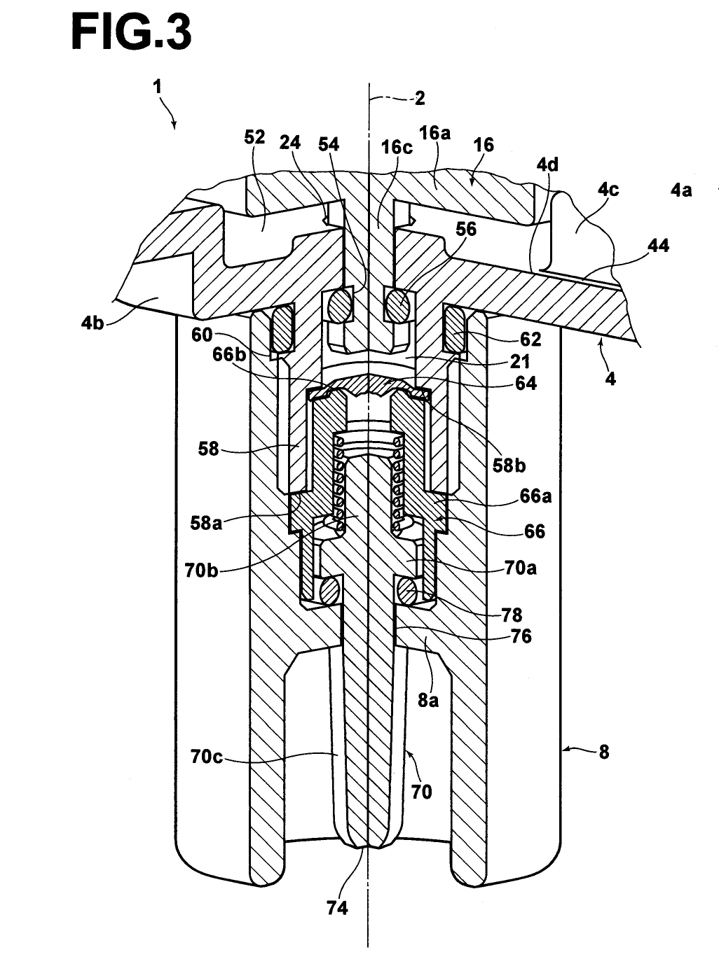

A pressure regulator in accordance with a first embodiment of the present invention will be described with reference to FIGS. 1 to 3, hereinbelow. FIG. 1 is an exploded perspective view showing a pressure regulator 1 in accordance with a first embodiment of the present invention cut along a circumference around a shaft 2 passing through the center thereof by a range of about 90 degrees, FIG. 2 is a fragmentary enlarged view of FIG. 1, and FIG. 3 is a fragmentary enlarged view showing a lower part of the pressure regulator 1 of FIG. 1 cut along a circumference around the shaft 2 by a range of about 90 degrees.

As shown in FIG. 1, the pressure regulator 1 has a housing 5 comprises a body casing 4, a cover casing 6 and an introduction tube 8 mounted on the body casing 4. The body casing 4 and the cover casing 6 respectively have bulgy portions 4b and 6b and have flanges 4a and 6a on their outer circumference which are similar to each other in shape. The bulgy portion 4b is formed with a through hole 24 (FIGS. 2 and 3) in a position corresponding to the shaft 2. The flange 4a of the body casing 4 and the flange 6a of the cover casing 6 buttes against each other and connected to each other, for instance, by screwing.

The butting face 10 (FIG. 1) of the flange 4a is provided with an indented portion 10a over the entire inner circumference of the flange 4a. A diaphragm 12 is disposed in the intended portion 10a and fixed between the flanges 4a and 6a in response to the fixture of the flanges 4a and 6a. The diaphragm 12 is an elastic plate-like member such as of a rubber and has a flexible portion 12a (FIG. 2) which is of a circular shape about the shaft 2. The diaphragm 12 is provided with a circular opening 22 (FIG. 2) opposed to the shaft 2. A supporter 14 is disposed on an upper part of the diaphragm 12 inside the flexible portion 12a.

On the side of the diaphragm 12 opposite to the supporter 14 is disposed a plunger 16. The diaphragm 12, supporter 14 and the plunger 16 are integrated and the integrated diaphragm 12, supporter 14 and the plunger 16 are referred to as “movable body 15” altogether. The terms “upper” and “lower” as used here are as seen in FIGS. 1 to 3. The supporter 14 has a flat plate portion 14a (FIG. 2) in contact with an upper surface 18 of the diaphragm 12 and a projection (abutment portion) 14b projecting upward from the flat plate portion 14a. Though it is preferred that the supporter 14 be made of light-weight material such as polyoximethylene, the supporter 14 may be made of metal. The upper surface 26 (FIG. 2) of the projection 14b is flat, and the projection 14b is formed with a female thread 14c (FIG. 2) along the shaft 2.

The plunger 16 is provided with a flat plate portion 16a on the lower side (a first surface) 20 of the diaphragm 12 and shafts 16b and 16c (FIG. 2) extending in the vertical direction of the flat plate portion 16a along the shaft 2. The shaft 16b projects upward through the opening 22 of the diaphragm 12 and the shaft 16c extends downward through the through hole 24 (FIGS. 2 and 3) of the body casing 4. The shaft 16b is provided with a male thread 17 which is in mesh with the female thread 14c of the supporter 14 to fasten the diaphragm 12 from the both sides. With this arrangement, the diaphragm 12 is sandwiched between the supporter 14 and the plunger 16 and is integrated therewith. It is preferred that film 29 (FIG. 2) of a material low in frictional characteristics such as PET (polyethylene terephthalate) intervenes between the supporter 14 and the diaphragm 12. With this arrangement, the diaphragm 12 cannot be deformed by the frictional force generated upon fastening the diaphragm 12 when the supporter 14 is brought into mesh with the shaft 16b.

A projection (stopper portion) 28 is formed on the inner side of the bulgy portion 6b of the cover casing 6 opposed to the projection 14b. The leading end face, or the lower surface 30 of the projection 28 is flat as the upper surface 26 of the supporter 14. A small hole 34 (FIG. 2) is formed in the center of the projection 28 to communicate external and the space 32 inside the bulgy portion 6b. Since external is normally at the atmospheric pressure, the inside of the space 32 is held at the atmospheric pressure. A coiled compression spring (will be referred to as “pressure control spring”, herein below) 36 is fitted on the projections 14b and 28 of the supporter 14 and the cover casing 6. The pressure control spring 36 normally urges downward the diaphragm 12 at a predetermined pressure by way of the supporter 14. A space G (FIG. 2) is normally assured between the projection 14b and the upper surface 26 of the supporter 14.

The cover casing 6 is formed with a bulgy portion 6c which laterally bulges from the bulgy portion 6b. The bulgy portion 6c is formed with a nozzle 40 which is formed therein a discharge port 38 and extends externally from the bulgy portion 6c. In the cover casing 6 is further formed a cylindrical space 42 communicating with the discharge port 38 by a partition wall 6d (FIG. 1). In a part of the body casing 4 opposed to the space 42 is formed a substantially cylindrical space 46 by a partition wall 4c. An end face 7 (FIGS. 1 and 2) of the partition wall 4c is seen in FIGS. 1 and 2, while the other end face of the partition wall 4c is in a position opposed to said one end face so that a groove 44 (FIGS. 2 and 3) is formed between the end faces. In a part of the body casing 4 facing the space 46, an upward facing annular indented portion 46a is formed. In the diaphragm 12, a circular opening 37 is formed opposed to the spaces 42 and 46 (FIG. 1). In the spaces 42 and 46, a sleeve 50 having a flange 50a is disposed through the opening 37 in the diaphragm 12 with the flange 50a seated in the indented portion 46a. The sleeve 50 is sized in its longitudinal direction so that a space is formed between its lower end and an inner surface 4d of the bulgy portion 4b (FIGS. 2 and 3) and forms a passage which leads to the discharge port 38 fluid passing through the groove 44. The sleeve 50 is formed, for instance, by polyoximethylene.

Between the bulgy portion 4b of the body casing 4, the plunger 16 and the diaphragm 12, a space, that is a pressure control chamber 52 is formed. An annular groove 54 (FIG. 2) is formed on the leading end potion of the shaft 16c of the plunger 16 projecting downward through the through hole 24 of the bulgy portion 4b and an O-ring 56 is mounted in the annular groove 54. The O-ring 56 forms the pressure control valve. That is, the O-ring 56 is driven up and down by the diaphragm 12 to change the flow of fluid between the shaft 16c and the through hole 24 of the bulgy portion 4b, thereby changing the fluid pressure in the pressure control chamber 52. The aforesaid pressure control spring 36, the movable body 15, the O-ring 56 and the like form the pressure control mechanism. An annular wall 58 extends downward to surround the leading end portion of the shaft 16c from the bulgy portion 4b of the body casing 4. On the outer circumference of the base end of the annular wall 58, a groove 60 (FIG. 2) is formed and an O-ring 62 is mounted in the groove 60.

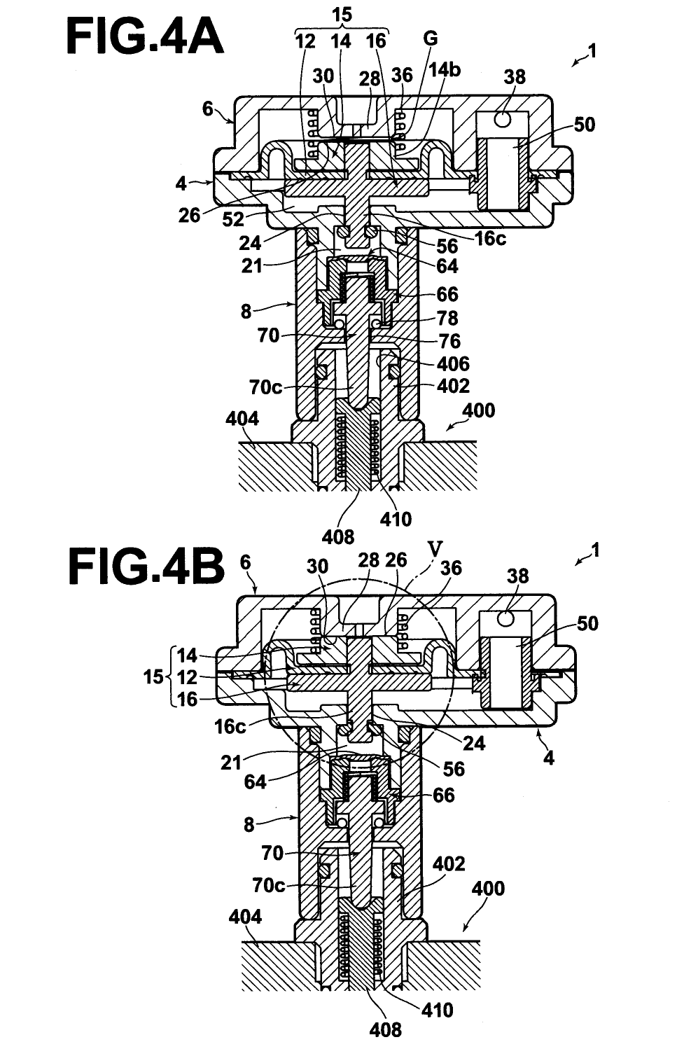

A thread (not shown) may be formed on the outer side of the annular wall 58 to be able to be engaged with the aforesaid introduction tube 8. The introduction tube 8 is a member to which a pressure vessel 400 to be described later (FIG. 4) is connected, and comprises a partition wall 8a in the middle in the longitudinal direction thereof. The partition wall 8a is provided with an opening 76 which receives a lower shaft 70c of a plug 70. A filter 64, a joint 66, a coiled compression spring 68 and the plug 70 are disposed in this order from upside between the partition wall 8a and the bulgy portion 4b. The joint 66 is a substantially tubular member which has an upper wall 66b and is formed, for instance, by polyoximethylene. In the center of the upper wall 66b of the joint 66, a hole 72 is formed and an annular flange 66a is formed between the upper wall 66b and the lower end 80 to extend toward the outside.

The filter 64 comprises a circular plate portion 64a and an annular wall 64b suspended from the outer periphery of the circular plate portion 64a. The filter 64 covers the upper wall 66b of the joint 66. In the assembled state, the flange 66a of the joint 66 abuts against a lower end 58a (FIG. 3) of the annular wall 58 to support the filter 64 between a downward facing indented portion 58b and the upper wall 66b of the joint 66. An intermediate chamber 21 into which the end portion of the shaft 16c of the plunger 16 projects is formed above the filter 64. A plurality of grooves 67 (FIG. 2) continuous in the vertical direction are formed on the inner surface 66c of the joint 66 spaced from each other in the direction of the inner circumference of the joint 66. The grooves 67 form a passage through which pressurized fluid to be supplied flows.

The plug 70 is like a pin formed by stainless steel or polyoximethylene and is provided with an annular flange 70a in its upper portion. An upper shaft 70b projecting upward beyond the flange 70a has a diameter able to be inserted inside the spring 68. The lower shaft 70c projecting downward beyond the flange 70a tapers toward a lower end 74. An O-ring 78 is mounted in the vicinity of the flange 70a of the lower shaft 70c.

When the introduction tube 8 is incorporated in the annular wall 58, the spring 68 and the plug 70 are held between upper wall 66b of the joint 66 and the partition wall 8a of the introduction tube 8. At this time, the flange 70a of the plug 70 is urged downward by the spring 68, and the O-ring 78 is pressed between the flange 70a and the partition wall 8a. The O-ring 78 is in close contact with the flange 70a and the partition wall 8a under the urging force of the spring 68 when the pressure vessel 400 is not connected to the introduction tube 8. With this arrangement, the pressurized fluid in the pressure regulator 1 is prevented from externally leaking between the lower shaft 70c of the plug 70 and the opening 76 of the partition wall 8a.

Use of the pressure vessel 400 such as a cartridge of a fuel cell connected to the pressure regulator 1 structured as described above will be described with reference to FIGS. 4 (4A and 4B), hereinbelow. FIG. 4 show the cross-sections of the pressure regulator 1 to which the pressure vessel 400 is connected. FIG. 4A shows a normal state of the pressure regulator 1, while FIG. 4B shows a state of the pressure regulator 1 where the pressure therein is increased excessively high. In FIG. 4, only a part of the pressure vessel is shown in cross-section. In FIG. 4, a fitting portion 402 inserted into the introduction tube 8 and a body portion 404 on which the fitting portion 402 is mounted are shown as a pressure vessel 400. An ejecting port 406 vertically extends through the fitting portion 402. A valve body 408 which is normally urged upward by a spring 410 to prevent ejection of the fluid in the pressure vessel 400 is held for sliding motion inside the ejecting port 406.

As shown in FIGS. 4A and 4B, the plug 70 is pressed upward by the valve body 408 when the pressure vessel 400 is mounted on the pressure regulator 1. The opening 76 of the introduction tube 8, which has been closed by the O-ring 78, is thereby opened and the pressurized fluid passes by the opening 76, the groove 67 inside the joint 66 and the filter 64 in this order. In the initial state of connection of the pressure vessel 400, since the fluid pressure in the pressure control chamber 52 is low, the diaphragm 12 is in a state where it is urged downward by the pressure control spring 36. Accordingly, since the O-ring 56 for sealing the through hole 24 of the body casing 4 is moved downward away from the through hole 24, the sealing of the through hole 24 has been released. Accordingly, the pressurized fluid passing by the passage 67, the filter 64, the intermediate chamber 21, the space between the through hole 24 and the shaft 16c, the pressure control chamber 52 and the sleeve 50 is supplied to an external device such as a fuel cell (not shown) through the discharge port 38.

In a normal state of use, the diaphragm 12 is set so that the pressure in the pressure control chamber 52 is a predetermined pressure under the force of the pressure control spring 36 with respect to a pressure of the supplied fluid, for instance, 900 KPa to 1 MPa. That is, when the pressure of the fluid to be supplied from the pressure vessel 400 exceeds the pressure of the fluid to be supplied, the fluid in the pressure control chamber 52 presses upward the diaphragm 12 overcoming the pressure control spring 36. As a result, the shaft 16c of the plunger 16 is moved upward and the O-ring seals the through hole 24 of the body casing 4, whereby the pressurized fluid is prevented from flowing into the pressure control chamber 52 any more. The pressure applied to the diaphragm 12 from the pressurized fluid, strictly speaking, includes not only the pressure in the pressure control chamber 52 but also a pressure applied to the pressure control valve including the O-ring 56 in the intermediate chamber 21. That is, since a pressure equal to the primary pressure in the intermediate chamber 21×projected area of the pressure control valve has been applied to the pressure control valve, the pressure control valve can close under the pressurized fluid and/or the O-ring 56 can slide into the valve seat to be deformed. When the pressure in the pressure control chamber 52 lowers, the shaft 16c of the plunger 16 is moved downward to open the through hole 24 under the urging force of the pressure control spring 36 to permit the pressurized fluid to flow into the pressure control chamber 52 again.

Thus, the diaphragm 12 constantly moves (vibrates) up and down in response to fluctuation in the fluid pressure. However, since the distance of up and down movement is very slight, for instance, about 0.3 mm, the aforesaid space G, that is, the space between the upper surface 26 of the projection 14b and the lower surface 30 of the projection 28 of the cover casing is held substantially constant in dimensions. Though in FIG. 4A representing a state where the pressurized fluid flows, the O-ring 56 is shown to be in contact with the body casing 4, actually there is a very little space between the O-ring 56 and the body casing 4, and the pressurized fluid can pass therethrough.

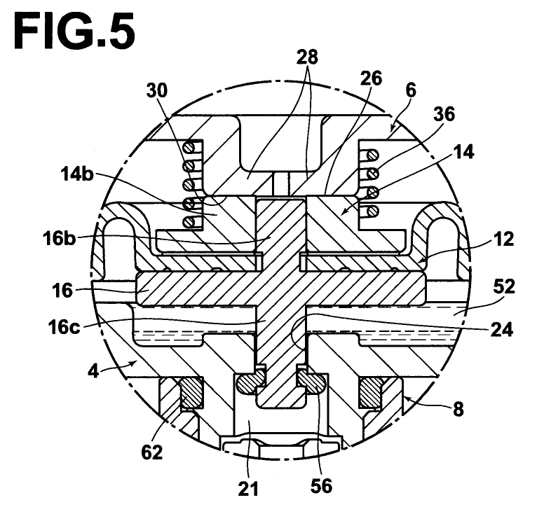

However, when the fluid pressure supplied from the pressure vessel 400 becomes excessively high for some reason, for instance, due to increase in the temperature of the pressure vessel 400 or collapse of the pressure vessel 400, the diaphragm 12 behaves in a way different from the normal as shown in FIG. 4B. That is, even if the through hole 24 is sealed by the O-ring 56, for instance, by an abnormally high pressure of the supplied fluid pressure, for instance, a pressure of 2 MPa to 3 MPa, the shaft 16c of the plunger 16 is pressed further upward beyond the intermediate chamber 21, that is, into the pressure control chamber 52. FIG. 5 shows the O-ring 56 in this state.

FIG. 5 shows a state of the diaphragm 12 when an excessively high pressure fluid is supplied and an enlarged view of the area V surrounded by the chained line in FIG. 4B. As can be seen from FIG. 5, the O-ring 56 starts to be deformed pressed by the body casing 4 in response to the upward movement of the shaft 16c of the plunger 16. In the state shown in FIG. 5, the O-ring 56 can still resiliently return to the original state. At this time, the upper surface 26 of the projection 14b of the supporter 14 abuts against the lower surface 30 of the projection 28 of the cover casing 6 which forms a part of the housing 5 and the diaphragm 12 is not displaced upward any more. With this arrangement, the O-ring 56 is broken or the shaft 16c is withdrawn upward from the through hole 24 and the pressurized fluid is prevented from leaking from the intermediate chamber 21 to the pressure control chamber 52. Though the intermediate chamber 21 and the pressure control chamber 52 are in communication with each other through a small space if the O-ring 56 is broken, the pressurized fluid is prevented from leaking to the external from the opening 76 even if the pressure vessel 400 is removed since the opening 76 is sealed by the plug 70 and the O-ring 78.

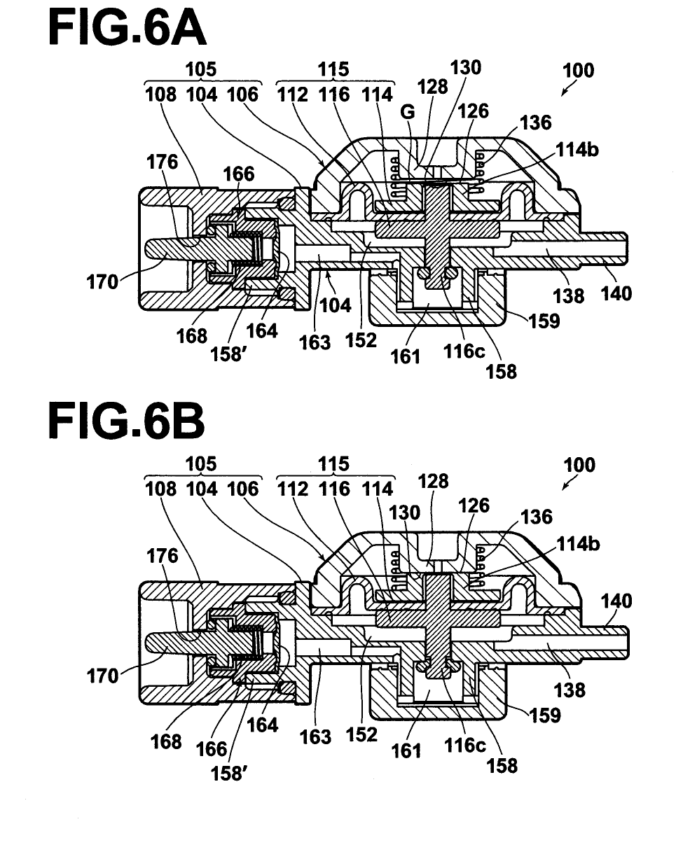

A pressure regulator 100 in accordance with a second embodiment of the present invention will be described with reference to FIG. 6 hereinbelow. FIG. 6 show a cross-section of the pressure regulator 100 in accordance with the second embodiment of the present invention and FIGS. 6A and 6B respectively show a normal state and a state where the pressure therein is increased excessively high of the pressure regulator 100. The pressure regulator 100 comprises a body casing 104, a cover casing 106, a diaphragm 112 disposed between the body casing 104 and the cover casing 106, a supporter 114 and a plunger 116 holding the diaphragm 112 on both sides, an introduction tube 108 which is laterally mounted on a side of the body casing 104 and has an inlet port 176, and a filter 164, a spring 168, and a plug 170 disposed in the introduction tube 108. The diaphragm 112, supporter 114 and the plunger 116 are altogether referred to as “the movable body”. The body casing 104, the cover casing 106 and the introduction tube 108 form a housing 105. In FIG. 6, the pressure vessel 400 is abbreviated.

As in the first embodiment, the body casing 104 is provided with an annular wall 158 projecting downward integrally therewith opposite to the plunger 116. On the outer side of the annular wall 158, a lid 196 is mounted on the annular wall 158, for instance, by screwing. With this arrangement, an intermediate chamber 161 is formed in the annular wall 158. Further, the body casing 104 is integrally formed with another annular wall 158′ similar to the annular wall 158 to laterally extend. On said another annular wall 158′, an introduction tube 108 similar to that in the first embodiment is mounted. Since the structure inside the introduction tube 108 and the structure of the diaphragm 112 and the supporter 114 and the plunger 116 supporting the diaphragm 112 are the same as those in the first embodiment, description in detail will be abbreviated.

In the body casing 104, a flow passage 163 which is the passage of the fluid from the introduction tube 108 to the intermediate chamber 161 and from the intermediate chamber 161 to the pressure control chamber 152 is formed. Further, the body casing 104 is provided with a nozzle 140 opposite to the introduction tube 108. The nozzle 140 is provided with a discharge port 138 communicating with the pressure control chamber 152.

The supporter 114 has a projection (abutment portion) 114b whose upper surface 126 is flat also in the second embodiment, and the lower surface 130 of the projection (stopper portion) 128 of the cover casing 106 is also flat. The supporter 114 is urged downward by the pressure control spring 136. A space G is normally formed between the upper surface 126 and the lower surface 130. Also in the second embodiment, when the fluid pressure supplied becomes excessively high, the shaft 116c of the plunger 116 is moved upward and the upper surface 126 of the projection 114b of the supporter 114 abuts against the lower surface 130 of the projection 128 of the cover casing 106 as shown in FIG. 6B, whereby excessive deformation of the diaphragm 112 is prevented.

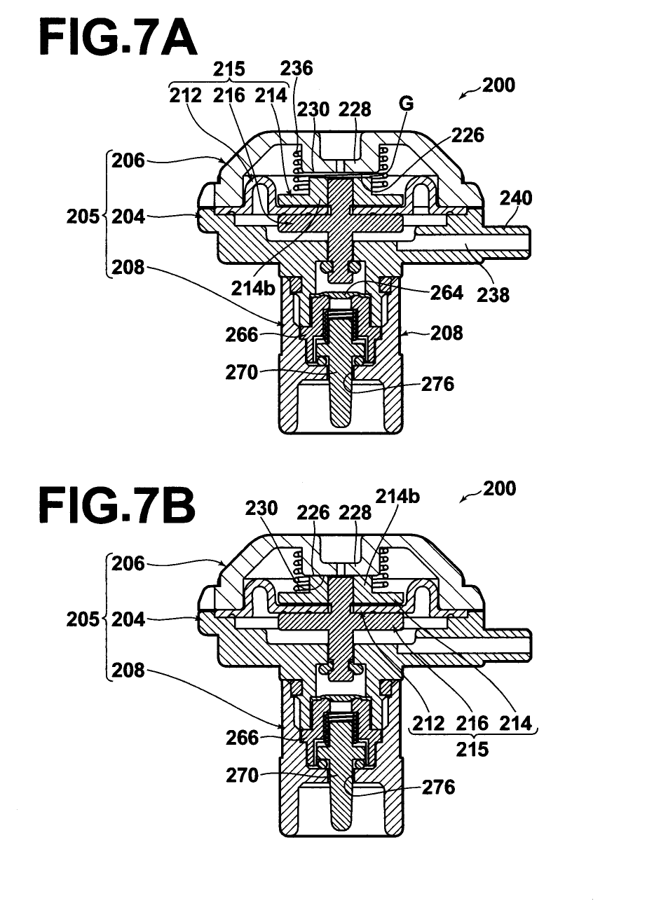

A pressure regulator 200 in accordance with a third embodiment of the present invention will be described with reference to FIGS. 7 (7A and 7B) hereinbelow. FIG. 7 show a cross-section of the pressure regulator 200 in accordance with the third embodiment of the present invention and FIGS. 7A and 7B respectively show a normal state and a state where the pressure therein is increased excessively high of the pressure regulator 200. The pressure regulator 200 has structure similar to the pressure regulator 1 of the first embodiment. That is, the pressure regulator 200 comprises a body casing 204, a cover casing 206, a diaphragm 212 disposed in the body casing 204 and the cover casing 206, a supporter 214 and a plunger 216 holding the diaphragm 212, an introduction tube 208 which has an inlet port 276, and a filter 264, a joint 266, and a plug 270 disposed in the similar positions to the pressure regulator 1 of the first embodiment. The diaphragm 212, supporter 214 and the plunger 216 are altogether referred to as “the movable body”. The body casing 204, the cover casing 206 and the introduction tube 208 form a housing 205. The pressure regulator 200 in accordance with the third embodiment mainly differs from the pressure regulator of the first embodiment in that the discharge port 238 and the nozzle 240 are provided on the body casing 204. In FIG. 7, the pressure vessel 400 is abbreviated. Accordingly, the sleeve 50 in the first embodiment is not employed in the third embodiment.

The supporter 214 has a projection (abutment portion) 214b whose upper surface 226 is flat also in the third embodiment, while the cover casing 206 is formed with a downward projection (stopper portion) 228 and the lower surface 230 of the projection 228 of the cover casing 206 is also flat. On the outer periphery of the projection 214b of the supporter 214 and the projection 228 of the cover casing 206, a pressure control spring 236 is disposed in a compressed state. The supporter 214 is urged downward under predetermined force by the pressure control spring 136. A space G is normally formed between the upper surface 226 and the lower surface 230. Also in the third embodiment, when the fluid pressure supplied becomes excessively high, the plunger 216 is moved upward and the upper surface as shown in FIG. 7B and the diaphragm 212 is moved upward, whereby the upper surface 226 of the projection 214b of the supporter 214 abuts against the lower surface 230 of the projection 228 of the cover casing 206 and excessive deformation of the diaphragm 112 is prevented.

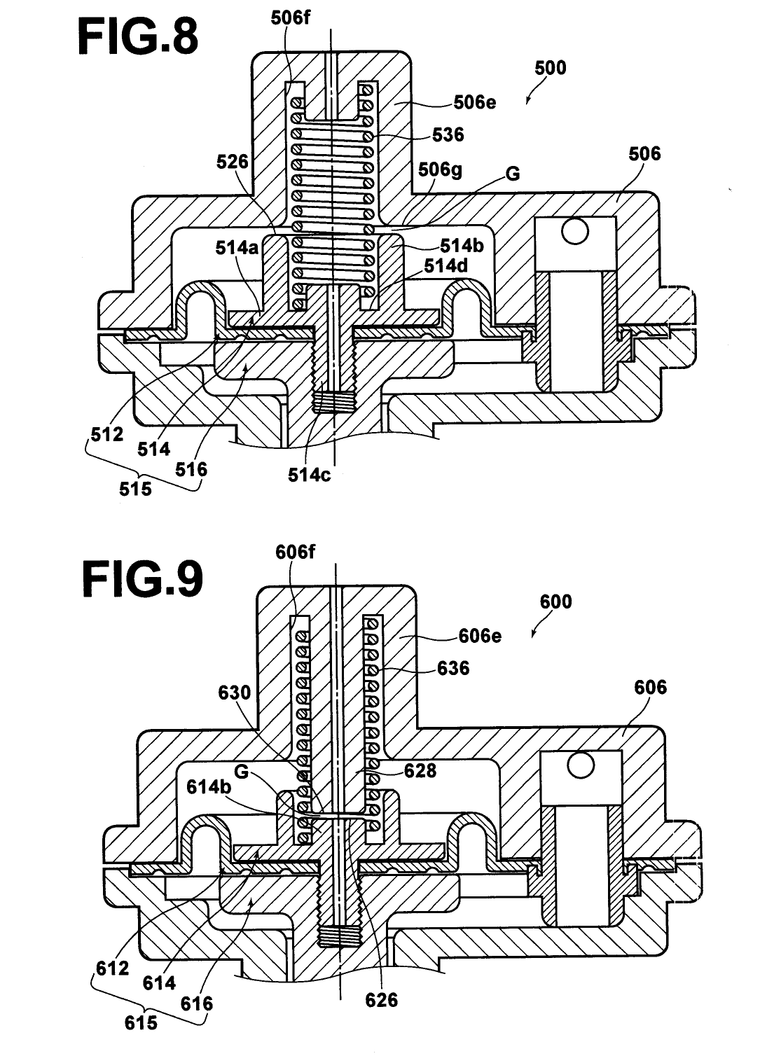

FIG. 8 is a fragmentary enlarged cross-sectional view showing a first modification of the projection 14b of the supporter 14 and the projection 228 of the cover casing 6 in the first embodiment, and FIG. 9 is a fragmentary enlarged cross-sectional view showing a second modification of the projection 14b of the supporter 14 and the projection 228 of the cover casing 6 in the first embodiment. In FIG. 8, the supporter 514 of the pressure regulator 500 comprises a circular flat plate portion 514a and a shaft 514c which projects upward and downward from the center of the flat plate portion 514a. The lower part of the shaft 514c is threaded to mesh with the plunger 516. The flat plate portion 514a is formed with an annular projection (abutment portion) 514b projecting upward coaxially with the shaft 514c. An annular groove or an annular recess 514d for receiving a pressure control spring 536 is formed in the projection 514b.

An upward projecting bearing portion 506e is formed in the cover casing 506 in a position opposed to the projection 514b, and another annular groove or an annular recess 506f for receiving a pressure control spring 536 is formed in the bearing portion 506e. The pressure control spring 536 is disposed between the recess 506f in the bearing portion 506e and the recess 514d of the projection 514b of the supporter 514 and urges downward the diaphragm 512 under a predetermined pressure by way of the supporter 514. In the first modification of the first embodiment, when the fluid pressure supplied becomes excessively high, the leading end or the upper surface 526 of the projection 514b abuts against the inner side (stopper portion) 506g of the cover casing 506 at a part opposed to the leading end or the upper surface 526. A space G is normally formed between the upper surface 526 and the inner side 506g. The diaphragm 512, supporter 514 and the plunger 516 are altogether referred to as “the movable body 515”.

A second modification of the projection 14b of the supporter 14 and the projection 28 of the cover casing 6 in the first embodiment of the present invention will be described with reference to FIG. 9, hereinbelow. In the pressure regulator 600 shown in FIG. 9, the supporter 614 has substantially the same structure as in the first modification. That is, the supporter 614 has an upward facing shaft (abutment portion) 614b at the center thereof. Whereas, a projection (stopper portion) 628 is formed in the annular groove or the recess 606f of the bearing portion 606e similar to that in the first modification to extend downward opposed to the shaft 614b. The lower surface 630 of the projection 628 is suspended to the vicinity of the upper surface 626 of the shaft 614b and a predetermined gap G is formed between the lower surface 630 and the upper surface 626. In the second modification, the upper surface 626 of the shaft 614b of the supporter 614 abuts against the lower surface 630 of the projection 628 of the cover casing 606 when the fluid pressure supplied becomes excessively high. Also in the second modification, the diaphragm 612, supporter 614 and the plunger 616 altogether form the movable body 615.

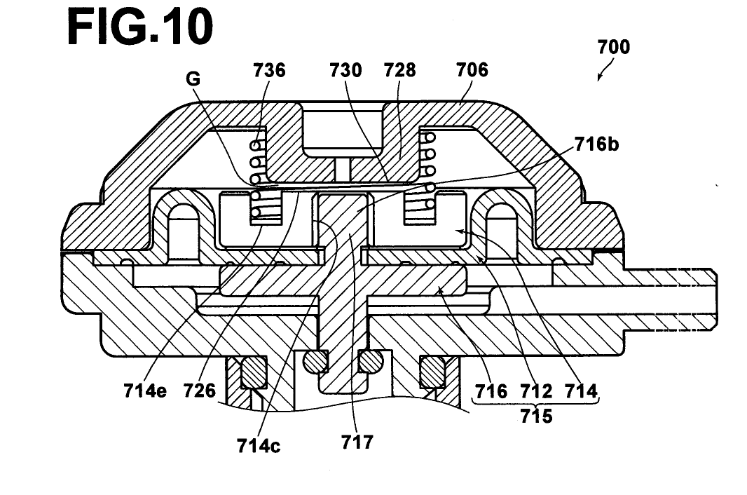

As a modification of the pressure regulator 200 in accordance with the third embodiment described above, a supporter 714 of a pressure regulator 700 will be described with reference to FIG. 10, hereinbelow. FIG. 10 is a partly enlarged view of a modification of the supporter employed in the third embodiment. The pressure regulator 700 is of the same structure as the pressure regulator 200 in accordance with the third embodiment described above except that the supporter 714 of the pressure regulator 700 has a different shape. That is, the supporter 714 is like a circular plate and has a female thread 714c at the center thereof and at the same time, is provided with an upward facing annular groove 714e formed coaxially with the female thread 714c. The female thread 714c is adapted to engage with a male thread 717 formed on the shaft 716b of the plunger 16. A pressure control spring 736 is disposed in the annular groove 714e. On the other hand, the cover casing 706 is provided with a projection (stopper portion) 728 which has a diameter accommodated in the pressure control spring 736 is formed opposed to the supporter 714. A predetermined gap G is formed between the lower surface 730 of the projection 728 and the upper surface 726 of the 3 supporter 714. In this modification, the upper surface 726 of the supporter 714 abuts against the lower surface 730 of the projection 728 when the fluid pressure supplied becomes excessively high. In this case, the abutment portion is the supporter 714 itself. Also in this modification, the diaphragm 712, supporter 714 and the plunger 716 altogether form the movable body 715.

Any one of the pressure control springs 36, 136, 236, and 736 employed in the first to third embodiments and the modification of the third embodiment described above is disposed on the outside of the projections 14b and 28, the projections 114b and 128, and the projections 214b and 228 and is thick in the line diameter while short in total length. On the other hand, any one of the pressure control springs 536, and 636 employed in the first and second modifications of the first embodiment described above is thin in the line diameter and long in total length. Generally, in the former pressure control spring, that is, in a pressure control spring which is thick in the line diameter and short in total length, the spring constant is large. Whereas, in the latter pressure control spring, that is, in a pressure control spring which is thin in the line diameter and long in total length, the spring constant is small. In the case of a spring which is small in spring constant, fluctuation of load applied to the diaphragm in positions to which the diaphragm is displaced in the vertical direction can be minimized, and the secondary pressure in the pressure control chamber can be set in a wide range. However, if it is not necessary to set the secondary pressure in the pressure control chamber, the pressure regulator may be small in size in the vertical direction. The shape of the pressure control spring may be suitably set so that the secondary pressure required to the fuel supplying body side such as the fuel cell can be satisfied. Accordingly, it is possible to dispose a pressure control spring which is large in spring constant and thickness and small in length between the projections 514b and 614b and the cover casings 506 and 606 in the first and second modifications shown in FIGS. 9 and 10.

Though embodiments of the present invention have been described above, when the pressure vessel 400 is mounted on the pressure regulators 1, 100 and 200, it is necessary a fixture system for holding the pressure vessel 400 in the mounted position. The fixture system may comprise simply a spring member such as a coiled compression spring or a leaf spring. Otherwise, the fixture system may comprise a fastener mechanism disclosed in Japanese Unexamined Patent Application No. 2004-266463 “PRESSURE REGULATOR” which we have filed Sep. 14, 2004. Other fixture system is variously conceivable. However, since being deviated from the scope of the invention, they will not be described in detail.

What is claimed is:

1. A pressure regulator comprising:
a housing having an inlet port through which pressurized fluid at a primary pressure is supplied, and a discharge port through which pressurized fluid at a secondary pressure lower than the primary pressure is discharged, and at the same time having a flow passage formed therein to extend from the inlet port to the discharge port, and a pressure control mechanism which is disposed on the flow passage to reduce the primary pressure to the secondary pressure, where the improvement comprises that
the pressure control mechanism comprises a movable body including a diaphragm which is displaced in response to change in the pressure of the fluid and the movable body is provided with an abutment portion which is brought into abutment against a part of the housing to prevent the movable body from being excessively displaced when the primary pressure becomes excessively high.

2. A pressure regulator as defined in claim 1 in which the movable body is provided with a pair of members which are associated with each other from a first surface facing the flow passage of the diaphragm and from a second surface opposite to the first surface to support therebetween the diaphragm and the abutment portion is formed in the portion projecting toward the second surface of the movable body.

3. A pressure regulator as defined in claim 1 in which the housing is formed with a stopper portion comprising a projection opposed to the abutment portion.

4. A pressure regulator as defined in claim 1 in which the abutment portion is a projection opposite to the inner surface of the housing.

5. A pressure regulator as defined in claim 2 in which the housing is formed with a stopper portion comprising a projection opposed to the abutment portion.

6. A pressure regulator as defined in claim 2 in which the abutment portion is a projection opposite to the inner surface of the housing.

7. A pressure regulator as defined in claim 3 in which the abutment portion is a projection opposite to the inner surface of the housing.

8. A pressure regulator as defined in claim 5 in which the abutment portion is a projection opposite to the inner surface of the housing.
